(19) United States
(12) Patent Application Publication
(10) Pub. No.: US 2026/0226203 A1
(43) Pub. Date: Aug. 6, 2026

(54) OLEFIN-BASED POLYMER AND PREPARATION METHOD THEREFOR

(71) Applicant: HANWHA SOLUTIONS CORPORATION, Seoul (KR)

(72) Inventors: Munhee LEE, Seoul (KR); Sung Dong KIM, Seoul (KR); Junho SEO, Seoul (KR); Hye Ran PARK, Seoul (KR); Ui Gab JOUNG, Seoul (KR); Jisong JO, Seoul (KR); Jeong Hyun PARK, Seoul (KR); Ji Ho KIM, Seoul (KR); Seong Jae LIM, Seoul (KR)

(73) Assignee: HANWHA SOLUTIONS CORPORATION, Seoul (KR)

(21) Appl. No.: 19/147,849

(22) PCT Filed: Dec. 20, 2023
(86) PCT No.: PCT/KR2023/021150

§ 371 Date: Jul. 14, 2025

(30) Foreign Application Priority Data
Jan. 20, 2023 (KR) 10-2023-0008669

(51) Int. Cl. C08F 4/6592; C08F 4/659; C08F 210/16

(52) U.S. Cl. CPC C08F 4/65925; C08F 4/65904; C08F 4/65912; C08F 4/65916; C08F 210/16

(57) ABSTRACT

An olefin-based polymer and a preparation method thereof are disclosed. The olefin-based polymer exhibits excellent processability and mechanical strength simultaneously. The olefin-based polymer satisfies the following Condition (1) below:

$$23.49 \leq \frac{MFR}{0.63} - {Pc}_{2} \leq 24. 762 \qquad Condition ( 1 )$$

wherein in Condition (1) above, the Pc₂ is the ethylene partial pressure (bar), and MFR represents

$$\frac{\begin{matrix}Melt flow index ( {I}_{21.6} , g / 10 min ) \\ measured under a load of 21.6 kg at 190 ° C .\end{matrix}}{\begin{matrix}Melt flow index ( {I}_{21.6} , g / 10 min ) \\ measured under a load of 21.6 kg at 190 ° C .\end{matrix}}$$

of the olefin-based polymer.

### TECHNICAL FIELD

The present invention relates to an olefin-based polymer, and more specifically to an olefin-based polymer which can simultaneously exhibit the effects of excellent processability, low density and excellent mechanical strength, and a preparation method therefor.

### BACKGROUND ART

Metallocene catalysts, which are one of the catalysts used to polymerize olefins, are compounds in which ligands such as cyclopentadienyl, indenyl and cycloheptadienyl are coordinated to transition metals or transition metal halogen compounds, and have a basic sandwich structure.

While Ziegler-Natta catalysts, which are another catalyst used to polymerize olefins, have metal components that are active sites dispersed on an inert solid surface such that the properties of the active sites are not uniform, metallocene catalysts are known as single-site catalysts because they are a single compound with a fixed structure such that all active sites have the same polymerization characteristics. Polymers polymerized with these metallocene catalysts have a narrow molecular weight distribution, a uniform distribution of comonomers and higher copolymerization activity than Ziegler-Natta catalysts.

Linear low-density polyethylene (LLDPE) is prepared by copolymerizing ethylene and alpha-olefin at low pressure using a polymerization catalyst. It has a narrow molecular weight distribution, short chain branches (SCB) of constant length, and generally does not have long chain branches (LCB). Films manufactured with linear low-density polyethylene have the characteristics of general polyethylene as well as high breaking strength and elongation, and excellent tear strength and impact strength, and thus, they are widely used in stretch films and overlap films where conventional low-density polyethylene or high-density polyethylene is difficult to apply.

Meanwhile, attempts have been made to polymerize olefin-based polymers using a single metallocene catalyst in the past, but the conventionally polymerized olefin-based polymers had problems with poor processability and mechanical strength.

Accordingly, there is an urgent need to develop an olefin-based polymer that has low density while ensuring excellent processability and mechanical strength.

### DISCLOSURE

### Technical Problem

The present invention has been devised to overcome the above-described problems, and an object of the present invention is to provide an olefin-based polymer which can simultaneously exhibit the effects of excellent processability, low density and excellent mechanical strength, and a preparation method therefor.

### Technical Solution

In order to solve the above-described problems, the present invention provides a method for preparing an olefin-based polymer, the method including preparing an olefin-based polymer by polymerizing an olefin-based monomer at a predetermined ethylene partial pressure under a catalyst, wherein the method satisfies Condition (1) below:

$$23.49 \leq \frac{MFR}{0.63} - {Pc}_{2} \leq 24. 762 \qquad ( 1 )$$

wherein in Condition (1) above, the Pc₂ is the ethylene partial pressure (bar), and MFR represents

$$\frac{\begin{matrix}Melt flow index ( {I}_{21.6} , g / 10 min ) \\ measured under a load of 21.6 kg at 190 ° C .\end{matrix}}{\begin{matrix}Melt flow index ( {I}_{21.6} , g / 10 min ) \\ measured under a load of 21.6 kg at 190 ° C .\end{matrix}}$$

of the olefin-based polymer.

According to an embodiment of the present invention, the olefin-based polymer may have a melt flow index of 0.5 to 1.5 g/10 min as measured under a load of 2.16 kg at 190° C. according to ASTM D1238, and a melt flow index of 20 to 30 g/10 min as measured under a load of 21.6 kg at 190° C.

In addition, the ethylene partial pressure may be 9.5 to 16.5 bar.

In addition, the catalyst may include a hybrid catalyst including a different first compound and second compound represented Chemical Formula 1 below:

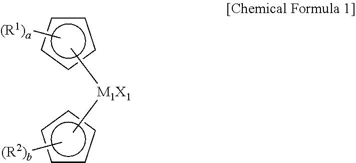

wherein in Chemical Formula 1 above,
M₁ may be titanium (Ti), zirconium (Zr) or hafnium (Hf),
wherein X₁ may be a halogen, a substituted or unsubstituted C₁ to C₅ alkyl group, a substituted or unsubstituted C₂ to C₅ alkenyl group, a substituted or unsubstituted C₁ to C₈ alkynyl group, a substituted or unsubstituted C₁ to C₅ alkoxy group, a substituted or unsubstituted C₆ to C₂₀ aryloxy group, a substituted or unsubstituted C₆ to C₂₀ aryl group, or a substituted or unsubstituted C₂ to C₂₀ heteroaryl group,
wherein R₁ and R₂ may be each independently hydrogen, deuterium, a substituted or unsubstituted C₁ to C₅ alkyl group, a substituted or unsubstituted C₂ to C₅ alkenyl group, a substituted or unsubstituted C₁ to C₈ alkynyl group, a substituted or unsubstituted C₁ to C₅ alkoxy group, a substituted or unsubstituted C₆ to C₂₀ aryloxy group, a substituted or unsubstituted C₆ to C₂₀ aryl group, or a substituted or unsubstituted C₂ to C₂₀ heteroaryl group, and
wherein a and b may be each independently an integer from 1 to 5.

In addition, the catalyst may further include a cocatalyst compound including at least any one of a compound represented by Chemical Formula 2 below, a compound represented by Chemical Formula 3 below and a compound represented by Chemical Formula 4 below:

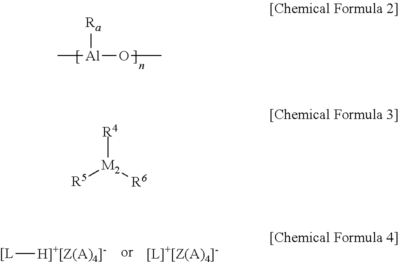

wherein in Chemical Formula 2 above, R₃ may be a halogen atom, or a C₁ to C₂₀ hydrocarbon group substituted or unsubstituted with a halogen, and n may be an integer of 2 or more,
wherein in Chemical Formula 3 above, M₂ may be aluminum (Al) or boron (B), and R⁴, R⁵ and R⁶ may be each independently a halogen atom, a C₁ to C₂₀ hydrocarbon group substituted or unsubstituted with a halogen, or a C to C₂₀ alkoxy group substituted or unsubstituted with a halogen, and
wherein in Chemical Formula 4 above, L may be a neutral or cationic Lewis base, [L-H]⁺ and [L]⁺ may be Bronsted acids, Z may be a Group 13 element, and A may be each independently a substituted or unsubstituted C₆ to C₂₀ aryl group, or a substituted or unsubstituted C₁ to C₂₀ alkyl group.

In addition, the catalyst may further include a carrier supporting at least any one of the hybrid catalyst and cocatalyst compound and including at least any one of silica, alumina and magnesia.

In addition, the present invention provides an olefin-based polymer that satisfies Condition (1) below:

$$23.49 \leq \frac{MFR}{0.63} - {Pc}_{2} \leq 24. 762 \qquad ( 1 )$$

wherein in Condition (1) above, the Pc₂ is the ethylene partial pressure (bar), and MFR represents

$$\frac{\begin{matrix}Melt flow index ( {I}_{21.6} , g / 10 min ) \\ measured under a load of 21.6 kg at 190 ° C .\end{matrix}}{\begin{matrix}Melt flow index ( {I}_{21.6} , g / 10 min ) \\ measured under a load of 21.6 kg at 190 ° C .\end{matrix}}$$

of the olefin-based polymer.

According to an embodiment of the present invention, the olefin-based polymer may have a melt flow index of 0.5 to 1.5 g/10 min as measured under a load of 2.16 kg at 190° C. according to ASTM D1238, and a melt flow index of 20 to 30 g/10 min as measured under a load of 21.6 kg at 190° C.

In addition, the olefin-based polymer may further satisfy Condition (2) below:

$$1.785 \leq \frac{Drop impact strength ( g )}{42} - {P}_{{C}_{2}} \leq 2.977 \qquad ( 2 )$$

wherein in Condition (2) above, the Pc₂ is the ethylene partial pressure (bar), and the drop impact strength represents a drop impact strength measured according to ASTM D1709.

In addition, the ethylene partial pressure may be 9.5 to 16.5 bar.

In addition, the olefin-based polymer may have a density of 0.915 to 0.935 kg/m³ and a drop impact strength of 520 g or more.

### Advantageous Effects

The olefin-based polymer according to the present invention and the preparation method therefor can simultaneously exhibit the effects of excellent processability, low density and excellent mechanical strength.

### BEST MODE

Hereinafter, embodiments of the present invention will be described in detail so that those skilled in the art can easily practice the present invention. The present invention may be implemented in various different forms and is not limited to the embodiments described herein.

As described above, in the case of conventional olefin-based polymers and the preparation methods therefor, there were problems in that processability and mechanical strength were poor due to the use of a metallocene single catalyst.

Accordingly, the present invention seeks to solve the above-described problems by providing a method for preparing an olefin-based polymer, including preparing an olefin-based polymer by polymerizing an olefin-based monomer under a catalyst at a predetermined ethylene partial pressure.

Through this, the present invention can simultaneously exhibit the effects of excellent processability, low density and excellent mechanical strength.

Meanwhile, the method for preparing an olefin-based polymer according to the present invention satisfies Condition (1) below.

As Condition (1),

$$23.49 \leq \frac{MFR}{0.63} - {Pc}_{2} \leq 24.762 , and preferably , 23.65 \leq \frac{MFR}{0.63} - {Pc}_{2} \leq 24.604 .$$

In this case, in Condition (1) above, the Pc2 is the ethylene partial pressure (bar), and MFR represents

$$\frac{\begin{matrix}Melt flow index ( {I}_{21.6} , g / 10 min ) \\ measured under a load of 21.6 kg at 190 ° C .\end{matrix}}{\begin{matrix}Melt flow index ( {I}_{21.6} , g / 10 min ) \\ measured under a load of 21.6 kg at 190 ° C .\end{matrix}}$$

of the olefin-based polymer.

If

$$\frac{MFR}{0.63} - {Pc}_{2}$$

is less than 23.49 in Condition (1) above, the mechanical strength may be low, and if

$$\frac{MFR}{0.63} - {Pc}_{2}$$

is more than 24.762, the processability may not be good, and even if the processability is good, the mechanical strength may be reduced and/or the density may increase.

Meanwhile, the step of preparing an olefin-based polymer by polymerizing an olefin-based monomer at a predetermined ethylene partial pressure under the catalyst may include preparing a catalyst and preparing an olefin-based polymer at a predetermined ethylene partial pressure.

First of all, the step of preparing a catalyst will be described.

According to an embodiment of the present invention, the catalyst may include a hybrid catalyst, and preferably, it may include a hybrid catalyst including a different first compound and second compound represented by Chemical Formula 1 below.

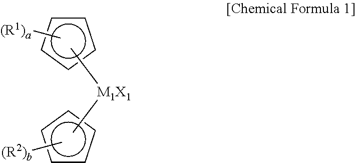

In Chemical Formula 1,
M₁ is titanium (Ti), zirconium (Zr) or hafnium (Hf),
X₁ is a halogen, a substituted or unsubstituted C₁ to C₅ alkyl group, a substituted or unsubstituted C₂ to C₅ alkenyl group, a substituted or unsubstituted C₁ to C₅ alkynyl group, a substituted or unsubstituted C₁ to C₅ alkoxy group, a substituted or unsubstituted C₆ to C₂₀ aryloxy group, a substituted or unsubstituted C₆ to C₂₀ aryl group, or a substituted or unsubstituted C₂ to C₂₀ heteroaryl group,
R₁ and R₂ are each independently hydrogen, deuterium, a substituted or unsubstituted C₁ to C₈ alkyl group, a substituted or unsubstituted C₂ to C₅ alkenyl group, a substituted or unsubstituted C₁ to C₅ alkynyl group, a substituted or unsubstituted C₁ to C₅ alkoxy group, a substituted or unsubstituted C₆ to C₂₀ aryloxy group, a substituted or unsubstituted C₆ to C₂₀ aryl group, or a substituted or unsubstituted C₂ to C₂₀ heteroaryl group, and
a and b are each independently an integer from 1 to 5.

Preferably, in Chemical Formula 1 above,
M₁ may be zirconium (Zr) or hafnium (Hf),
X₁ may be a halogen, a substituted or unsubstituted C₁ to C₅ alkyl group, a substituted or unsubstituted C₂ to C₅ alkenyl group, a substituted or unsubstituted C₁ to C₅ alkynyl group, or a substituted or unsubstituted C₁ to C₅ alkoxy group, and
R¹ and R² may each independently be hydrogen, a substituted or unsubstituted C₁ to C₅ alkyl group, a substituted or unsubstituted C₂ to C₅ alkenyl group, a substituted or unsubstituted C₁ to C₈ alkynyl group, or a substituted or unsubstituted C₁ to C₅ alkoxy group.

Meanwhile, the first compound may preferably be a compound represented by Chemical Formula 1-1 below, and the second compound may preferably be a compound represented by Chemical Formula 1-2 below.

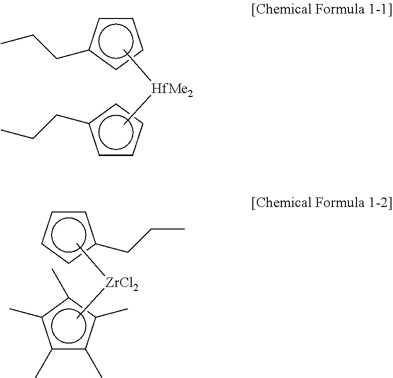

By satisfying Condition (1) described above and including the hybrid catalyst, it may be advantageous in achieving the object of the present invention, and by satisfying Condition (1) described above and including the first compound and the second compound, it may be more advantageous in achieving the object of the present invention, and by satisfying Condition (1) described above and including the first compound represented by Chemical Formula 1-1 above and the second compound represented by Compound 1-2 above, it may be more advantageous in achieving the object of the present invention.

Meanwhile, when the catalyst is a hybrid catalyst including the first compound and the second compound, the hybrid catalyst may include the first compound and the second compound in a weight ratio of 1:0.1 to 0.8, and preferably, the first compound and the second compound in a weight ratio of 1:0.12 to 0.7. When the weight ratio of the first compound and the second compound satisfies the above range, it may be more advantageous in achieving the object of the present invention.

According to an embodiment of the present invention, the catalyst may further include a cocatalyst compound, and preferably, the cocatalyst compound may include at least any one of a compound represented by Chemical Formula 2 below, a compound represented by Chemical Formula 3 below and a compound represented by Chemical Formula 4 below.

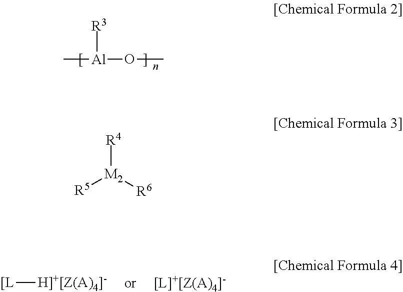

In Chemical Formula 2 above, R₃ is a halogen atom, or a C₁ to C₂₀ hydrocarbon group substituted or unsubstituted with a halogen, and n is an integer of 2 or more,
in Chemical Formula 3 above, M₂ is aluminum (Al) or boron (B), and R⁴, R⁵ and R⁶ are each independently a halogen atom, a C₁ to C₂₀ hydrocarbon group substituted or unsubstituted with a halogen, or a C₁ to C₂₀ alkoxy group substituted or unsubstituted with a halogen, and

in Chemical Formula 4 above, L is a neutral or cationic Lewis base, [L-H]⁺ and [L]⁺ are Bronsted acids, Z is a Group 13 element, and A is each independently a substituted or unsubstituted C₆ to C₂₀ aryl group, or a substituted or unsubstituted C₁ to C₂₀ alkyl group.

Meanwhile, more preferably, the cocatalyst compound may include aluminoxane, and more preferably, the aluminoxane may be methyl aluminoxane (MAO), and thus, it may be more advantageous in achieving the object of the present invention.

In addition, according to an embodiment of the present invention, the catalyst may further include a carrier supporting at least any one of the hybrid catalyst and the cocatalyst compound, and preferably, a carrier supporting the hybrid catalyst and the cocatalyst compound.

For the carrier, any known carrier may be used without limitation as long as it is a carrier that can support the above-described hybrid catalyst and the cocatalyst compound, but preferably, it may be more advantageous in achieving the object of the present invention to include at least any one of silica, alumina and magnesia, and more preferably, silica.

As described above, when the catalyst includes the above-described carrier, the above-described hybrid catalyst supported on the carrier and the above-described cocatalyst compound, the step of preparing a catalyst may include forming a mixed catalyst by mixing a hybrid catalyst and a cocatalyst compound; supporting the hybrid catalyst and the cocatalyst compound on the carrier by mixing the mixed catalyst, the carrier and the solvent; and drying the carrier supporting the hybrid catalyst and the cocatalyst compound.

The mixed catalyst may be formed by mixing the hybrid catalyst and the cocatalyst compound, and the cocatalyst compound may be mixed in a cocatalyst solution at a concentration of 5 to 15%. The mixing of the hybrid catalyst and the cocatalyst compound may be performed by mixing the hybrid catalyst and the cocatalyst solution in a weight ratio of 1:130 to 180, and preferably, the hybrid catalyst and the cocatalyst solution in a weight ratio of 1:140 to 170. As the weight ratio of the hybrid catalyst and the cocatalyst solution is satisfied, it may be more advantageous in achieving the object of the present invention. In this case, the solvent of the cocatalyst solution may be the same as or different from the solvent used in the supporting step described below, but is not limited thereto.

In addition, the step of supporting may mix the mixed catalyst (including the solvent of the cocatalyst solution) and the carrier in a weight ratio of 1:0.1 to 0.35, and preferably, the mixed catalyst and the carrier in a weight ratio of 1:0.12 to 0.32, and the solvent may be mixed in an amount of 150 to 350 parts by weight, and preferably, 200 to 300 parts by weight, based on 100 parts by weight of the carrier. As the weight ratio and solvent content range of the mixed catalyst and the carrier are satisfied, it may be more advantageous in achieving the object of the present invention. In this case, the solvent may be used without limitation as long as it is a solvent that can be commonly used in the art, and preferably, it may include toluene, but is not limited thereto.

Meanwhile, the step of supporting may be performed at a temperature of 55 to 85° C. for 1 to 3 hours, and preferably, at a temperature of 60 to 80° C. for 1.5 to 2.5 hours, but is not limited thereto.

In addition, the step of drying the carrier supporting the hybrid catalyst and cocatalyst compound may be performed under vacuum conditions at a temperature of 45 to 75° C. for 8 to 14 hours, and preferably, at a temperature of 50 to 70° C. for 9 to 13 hours, but is not limited thereto.

Next, the step of preparing an olefin-based polymer at a predetermined ethylene partial pressure is described.

The step of preparing an olefin-based polymer is performed by polymerizing an olefin-based monomer at a predetermined ethylene partial pressure, and the ethylene partial pressure may be 9.5 to 16.5 bar, and preferably 9.8 to 16.2 bar, so as to satisfy Condition (1) above. If the ethylene partial pressure is less than 9.5 bar, the mechanical strength may be reduced, and if the ethylene partial pressure is more than 16.5 bar, the processability may be reduced, and even if the processability is good, the mechanical strength may be reduced and/or the density may increase.

In addition, the olefin-based monomer may be at least one selected from the group consisting of C₂ to C₂₀ alpha-olefin, C₁ to C₂₀ diolefin, C₃ to C₂₀ cycloolefin and C₃ to C₂₀ cyclodiolefin, and preferably, it may be at least any one of ethylene, propylene, 1-butene, 1-pentene, 4-methyl-1-pentene, 1-hexene, 1-heptene, 1-octene, 1-decene, 1-undecene, 1-dodecene, 1-tetradecene or 1-hexadecene.

Meanwhile, the olefin-based polymer prepared through the above-described preparation method may have a melt flow index of 0.5 to 1.5 g/10 min as measured under a load of 2.16 kg at 190° C. according to ASTM D1238, and a melt flow index of 20 to 30 g/10 min as measured under a load of 21.6 kg at 190° C. in order to satisfy Condition (1) above, and preferably, the melt flow index as measured under a load of 2.16 kg at 190° C. according to ASTM D1238 may be 0.6 to 1.4 g/10 min, and the melt flow index as measured under a load of 21.6 kg at 190° C. may be 20.5 to 29 g/10 min. According to the above ASTM D1238, as the melt flow index measured under a load of 2.16 kg at 190° C. and the melt flow index measured under a load of 21.1 kg at 190° C. are satisfied, the olefin-based polymer may simultaneously exhibit the effects of low density, excellent processability and excellent mechanical strength.

The method for preparing an olefin-based polymer according to the present invention has been described above, but this is only an example, and additional processes and conditions may be further included.

In addition, the present invention provides an olefin-based polymer satisfying Condition (1) below.

As condition (1),

$$23.49 \leq \frac{MFR}{0.63} - {Pc}_{2} \leq 24.762 , and preferably , 23.65 \leq \frac{MFR}{0.63} - {Pc}_{2} \leq 24.604 .$$

In this case, in Condition (1) above, the Pc₂ is the ethylene partial pressure (bar), and MFR represents

$$\frac{\begin{matrix}Melt flow index ( {I}_{21.6} , g / 10 min ) \\ measured under a load of 21.6 kg at 190 ° C .\end{matrix}}{\begin{matrix}Melt flow index ( {I}_{21.6} , g / 10 min ) \\ measured under a load of 21.6 kg at 190 ° C .\end{matrix}}$$

of the olefin-based polymer.

The description of Condition (1) and the factors related thereto, such as ethylene partial pressure and melt flow index, are omitted as they are the same as the descriptions in the above-described method for preparing an olefin-based polymer.

Meanwhile, the olefin-based polymer according to the present invention may further satisfy Condition (2) below.

As Condition (2),

$$1.785 \leq \frac{Drop impact strength ( g )}{42} - {P}_{{C}_{2}} \leq 2.9 \; 77 , and \\ 1.809 \leq \frac{Drop impact strength ( g )}{42} - {P}_{{C}_{2}} \leq 2.858 .$$

In this case, the drop impact strength in Condition (2) above represents a drop impact strength measured according to ASTM D1709.

If, in Condition (2) above,

$$\frac{Drop impact strength ( g )}{42} - {P}_{{C}_{2}}$$

is less than 1.785, the mechanical strength of the olefin-based polymer may not be good, and if

$$\frac{Drop impact strength ( g )}{42} - {P}_{{C}_{2}}$$

is more than 2.977, the processability of the olefin-based polymer may not be good, and even if the processability is good, the mechanical strength may decrease and/or the density may increase.

Meanwhile, the olefin-based polymer according to the present invention may have a density of 0.915 to 0.935 kg/m², and preferably, the olefin-based polymer may have a density of 0.916 to 0.933 kg/m². If the density of the olefin-based polymer is less than 0.915 kg/m², the mechanical properties of the olefin-based polymer may not be good, and if the density is more than 0.935 kg/m², the processability may not be good.

In addition, the olefin-based polymer according to the present invention may have a drop impact strength of 520 g or more, and preferably, 540 g or more. Accordingly, it is possible to achieve an effect with excellent strength despite low density.

### MODES OF THE INVENTION

Hereinafter, the present invention will be described in more detail through examples, but the following examples do not limit the scope of the present invention, and should be interpreted as helping to understand the present invention

### Preparation Example: Preparation of Hybrid Catalyst

A first compound represented by Chemical Formula 1-1 below and a second compound represented by Chemical Formula 1-2 below were purchased from MCN Material Technologies (Shanghai), and a hybrid catalyst was prepared without a separate additional purification process. In this case, 8.1 kg of the first compound represented by Chemical Formula 1-1 below and 3.4 kg of the compound represented by Chemical Formula 1-2 below were prepared.

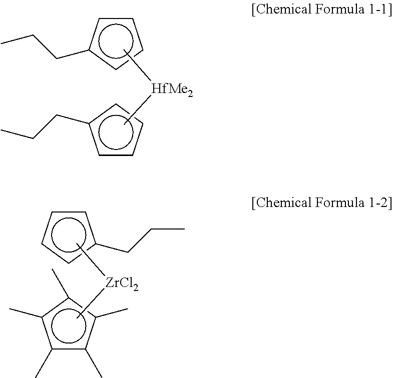

### Example: Preparation of Catalyst

The entire amount of the hybrid catalyst prepared according to the above preparation example and 1,800 kg of a cocatalyst solution including toluene as a solvent and methylaluminoxane as a cocatalyst compound at a concentration of 10% were stirred at 25° C. for 1 hour to prepare a mixed catalyst.

Then, the prepared mixed catalyst and 400 kg of silica (XPO-2402) as a carrier were introduced, 1,000 L of toluene was additionally added as a solvent, stirred at 70° C. for 2 hours, washed 3 times with 100 L of toluene, and dried under vacuum at 60° C. for 12 hours to obtain 560 kg of a catalyst.

### Preparation Examples 1 to 4 and Comparative Preparation Examples 1 to 2: Preparation of Olefin-Based Polymers

An ethylene/1-hexene polymerization reaction was performed by using a continuous gas phase polymerization reactor consisting of a fluidized bed. As shown in Tables 1 and 2 below, the hydrogen and 1-hexene input amounts were adjusted, and the ethylene partial pressure was adjusted to prepare olefin-based polymers as shown in Tables 1 and 2.

### Comparative Preparation Examples 3 and 4

Linear low-density polyethylene polymers (M1810HN, Hanwha Solutions) sold by Hanwha Solutions were prepared, except that each olefin-based polymer was prepared by changing the conditions as shown in Table 2 below.

### Experimental Example

The following physical properties were evaluated for the olefin-based polymers prepared according to the above preparation examples and comparative preparation examples, and the results are shown in Tables 1 and 2.

### 1. Measurement of Melt Flow Index

For each olefin-based polymer prepared according to the preparation examples and comparative preparation examples, the melt flow index (I_{21.6}) was measured under a load of 21.6 kg (a weight of 21.6 kg) at 190° C. in accordance with ASTM D 1238, and the melt flow index (12.16) was measured under a load of 2.16 kg (a weight of 2.16 kg) at 190° C., and then, the melt flow index ratio (MFR, processability) was measured by calculating I_{21.6}/I_{2.16}.

### 2. Measurement of Density

For each olefin-based polymer prepared according to the preparation examples and comparative preparation examples, the density was measured in accordance with ASTM D1505.

### 3. Measurement of Drop Impact Strength

For each olefin-based polymer prepared according to the preparation examples and comparative preparation examples, the drop impact strength was measured in accordance with ASTM D1709.

TABLE 1

| | Preparation | Preparation | Preparation | Preparation |
|---|---|---|---|---|
| Classification | Example 1 | Example 2 | Example 3 | Example 4 |
| Type of Catalyst | Example | Example | Example | Example |
| Polymerization Temperature | 88.7 | 88.6 | 88.2 | 88.8 |
| Amount of Catalyst Injection (kg/h) | 2.2 | 2.0 | 2.2 | 2.1 |
| Amount of Hydrogen Injection (kg/h) | 0.51 | 0.50 | 0.54 | 0.47 |
| Amount of 1-Hexene Injection (ton/h) | 1.21 | 1.18 | 1.15 | 1.11 |
| Concentration Ratio of | 0.053 | 0.046 | 0.057 | 0.054 |
| Hydrogen/Ethylene (%) | | | | |
| Concentration Ratio of 1-Hexene | 2.1 | 1.9 | 1.5 | 2.0 |
| Ethylene (%) | | | | |
| Amount of Polymer Production Per | 16.1 | 15.4 | 15.8 | 15.9 |
| Hour (MT/h) | | | | |
| Ethylene Partial Pressure (Pc₂, bar) | 10.4 | 13.9 | 14.8 | 10.1 |
| Melt Flow Index (I_{21.6}, g/10 min) | 22.0 | 24.4 | 26.0 | 21.4 |
| Melt Flow Index (I_{2.16}, g/10 min) | 1.01 | 1.02 | 1.06 | 1.01 |
| Ratio of Melt Flow Indexes (MFR, | 21.8 | 23.9 | 24.5 | 21.2 |
| I_{21.6}/I_{2.16}) | | | | |
| Condition 1, (MFR/0.63)-Pc₂ | 24.175 | 24.071 | 24.134 | 23.532 |
| Density (kg/cm³) | 0.9198 | 0.9200 | 0.9204 | 0.9197 |
| Drop Impact Strength (g) | 550 | 660 | 720 | 500 |
| Condition 2, (Drop Impact | 2.695 | 1.814 | 2.343 | 1.805 |
| Strength/42)- Pc₂ | | | | |

TABLE 2

| | Comparative | Comparative | Comparative | Comparative |
|---|---|---|---|---|
| | Preparation | Preparation | Preparation | Preparation |
| Classification | Example 1 | Example 2 | Example 3 | Example 4 |
| Type of Catalyst | Example | Example | — | — |
| Polymerization Temperature | 89.1 | 74.8 | 85 | 85.3 |
| Amount of Catalyst Injection (kg/h) | 2.2 | 1.97 | 2.6 | 2.8 |
| Amount of Hydrogen Injection (kg/h) | 0.46 | 2.28 | 0.29 | 0.31 |
| Amount of 1-Hexene Injection (ton/h) | 1.14 | 1.53 | 1.11 | 1.10 |
| Concentration Ratio of | 0.054 | 0.045 | 0.025 | 0.023 |
| Hydrogen/Ethylene (%) | | | | |
| Concentration Ratio of 1-Hexene | 2.2 | 1.45 | 2.5 | 2.7 |
| Ethylene (%) | | | | |
| Amount of Polymer Production Per | 15.7 | 15.75 | 15.5 | 15.8 |
| Hour (MT/h) | | | | |
| Ethylene Partial Pressure (Pc₂, bar) | 9.3 | 14.71 | 12.9 | 15.9 |
| Melt Flow Index (I_{21.6}, g/10 min) | 20.6 | 27.8 | 16.1 | 15.9 |
| Melt Flow Index (I_{2.16}, g/10 min) | 1 | 1.11 | 1.01 | 1.04 |
| Ratio of Melt Flow Indexes (MFR, | 20.6 | 25.0 | 15.9 | 15.4 |
| I_{21.6}/I_{2.16}) | | | | |
| Condition 1, (MFR/0.63)-Pc₂ | 23.40 | 25.044 | 12.403 | 8.367 |
| Density (kg/cm³) | 0.9130 | 0.9372 | 0.9199 | 0.9197 |
| Drop Impact Strength (g) | 465 | 760 | 400 | 420 |
| Condition 2, (Drop Impact | 1.771 | 3.385 | −3.376 | −5.900 |
| Strength/42)- Pc₂ | | | | |

As can be confirmed from Table 1 and Table 2 above, it can be seen that Preparation Examples 1 to 4, which satisfied all of the preparation conditions and physical properties (ethylene partial pressure, melt flow index ratio, etc.) of the olefin-based polymer of the present invention, simultaneously exhibited significantly superior effects in processability and mechanical properties compared to Comparative Preparation Examples 1 to 4, which did not satisfy even one of the above.

Meanwhile, Comparative Preparation Example 2 had a level of strength and mechanical strength that was not poor, but this was due to the significantly high density, and it can be seen that it did not meet the object of the present invention, which aims excellent processability, low density and high strength.

Although one embodiment of the present invention has been described above, the spirit of the present invention is not limited to the embodiments presented in the present specification, and those skilled in the art who understand the idea of the present invention will be able to easily propose other embodiments by modifying, changing, deleting or adding components within the scope of the same idea, but this will also be considered to fall within the scope of the idea of the present invention.

1. A method for preparing an olefin-based polymer, the method comprising:
preparing an olefin-based polymer by polymerizing an olefin-based monomer at a predetermined ethylene partial pressure under a catalyst,
wherein the method satisfies Condition (1) below:
$$23.49 \leq \frac{MFR}{0.63} - {Pc}_{2} \leq 24.762 \qquad ( 1 )$$
wherein in Condition (1) above, the Pc₂ is the ethylene partial pressure (bar), and MFR represents
$$\frac{\begin{matrix}Melt flow index ( {I}_{21.6} , g / 10 min ) \\ measured under a load of 21.6 kg at 190 ° C .\end{matrix}}{\begin{matrix}Melt flow index ( {I}_{21.6} , g / 10 min ) \\ measured under a load of 21.6 kg at 190 ° C .\end{matrix}}$$
of the olefin-based polymer.

2. The method of claim 1, wherein the olefin-based polymer has a melt flow index of 0.5 to 1.5 g/10 min as measured under a load of 2.16 kg at 190° C. according to ASTM D1238, and a melt flow index of 20 to 30 g/10 min as measured under a load of 21.6 kg at 190° C.

3. The method of claim 1, wherein the ethylene partial pressure is 9.5 to 16.5 bar.

4. The method of claim 1, wherein the catalyst comprises a hybrid catalyst comprising a different first compound and second compound represented Chemical Formula 1 below: 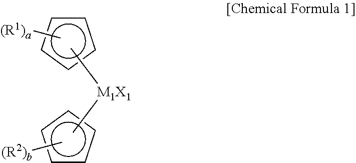
wherein in Chemical Formula 1 above, M₁ is titanium (Ti), zirconium (Zr) or hafnium (Hf),
wherein X₁ is a halogen, a substituted or unsubstituted C₁ to C₈ alkyl group, a substituted or unsubstituted C₂ to C₅ alkenyl group, a substituted or unsubstituted C₁ to C₅ alkynyl group, a substituted or unsubstituted C₁ to C₅ alkoxy group, a substituted or unsubstituted C₆ to C₂₀ aryloxy group, a substituted or unsubstituted C₆ to C₂₀ aryl group, or a substituted or unsubstituted C₂ to C₂₀ heteroaryl group,
wherein R₁ and R₂ are each independently hydrogen, deuterium, a substituted or unsubstituted C₁ to C₈ alkyl group, a substituted or unsubstituted C₂ to C₅ alkenyl group, a substituted or unsubstituted C₁ to C₅ alkynyl group, a substituted or unsubstituted C₁ to C₅ alkoxy group, a substituted or unsubstituted C₆ to C₂₀ aryloxy group, a substituted or unsubstituted C₆ to C₂₀ aryl group, or a substituted or unsubstituted C₂ to C₂₀ heteroaryl group, and
wherein a and b are each independently an integer from 1 to 5.

5. The method of claim 4, wherein the catalyst further comprises a cocatalyst compound comprising at least any one of a compound represented by Chemical Formula 2 below, a compound represented by Chemical Formula 3 below and a compound represented by Chemical Formula 4 below: 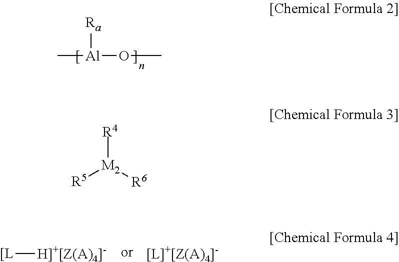
wherein in Chemical Formula 2 above, R₃ is a halogen atom, or a C₁ to C₂₀ hydrocarbon group substituted or unsubstituted with a halogen, and n is an integer of 2 or more,
wherein in Chemical Formula 3 above, M₂ is aluminum (Al) or boron (B), and R⁴, R⁵ and R₆ are each independently a halogen atom, a C₁ to C₂₀ hydrocarbon group substituted or unsubstituted with a halogen, or a C₁ to C₂₀ alkoxy group substituted or unsubstituted with a halogen, and
wherein in Chemical Formula 4 above, L is a neutral or cationic Lewis base, [L-H]⁺ and [L]⁺ are Bronsted acids, Z is a Group 13 element, and A is each independently a substituted or unsubstituted C₆ to C₂₀ aryl group, or a substituted or unsubstituted C₁ to C₂₀ alkyl group.

6. The method of claim 5, wherein the catalyst further comprises a carrier supporting at least any one of the hybrid catalyst and cocatalyst compound and comprising at least any one of silica, alumina and magnesia.

7. An olefin-based polymer that satisfies Condition (1) below:
$$23.49 \leq \frac{MFR}{0.63} - {Pc}_{2} \leq 24.762 \qquad ( 1 )$$
wherein in Condition (1) above, the Pc₂ is the ethylene partial pressure (bar), and MFR represents
$$\frac{\begin{matrix}Melt flow index ( {I}_{21.6} , g / 10 min ) \\ measured under a load of 21.6 kg at 190 ° C .\end{matrix}}{\begin{matrix}Melt flow index ( {I}_{21.6} , g / 10 min ) \\ measured under a load of 21.6 kg at 190 ° C .\end{matrix}}$$
of the olefin-based polymer.

8. The olefin-based polymer of claim 7, wherein the olefin-based polymer has a melt flow index of 0.5 to 1.5 g/10 min as measured under a load of 2.16 kg at 190° C. according to ASTM D1238, and a melt flow index of 20 to 30 g/10 min as measured under a load of 21.6 kg at 190° C.

9. The olefin-based polymer of claim 7, wherein the olefin-based polymer further satisfies Condition (2) below:
$$1.785 \leq \frac{Drop impact strength ( g )}{42} - {P}_{{C}_{2}} \leq 2.977 \qquad ( 2 )$$
wherein in Condition (2) above, the Pc₂ is the ethylene partial pressure (bar), and the drop impact strength represents a drop impact strength measured according to ASTM D1709.

10. The olefin-based polymer according to claim 7, wherein the ethylene partial pressure is 9.5 to 16.5 bar.

11. The olefin-based polymer of claim 7, wherein the olefin-based polymer has a density of 0.915 to 0.935 kg/m³ and a drop impact strength of 520 g or more.
